(19) United States
(12) Patent Application Publication
(10) Pub. No.: US 2026/0195900 A1
(43) Pub. Date: Jul. 9, 2026

(54) DETECTION OF ROTATIONAL IMAGING CATHETER TWIST USING IMAGE CORRELATION

(71) Applicant: Boston Scientific Scimed, Inc., Maple Grove, MN (US)

(72) Inventors: Timothy G. Curran, St. Paul, MN (US); Wenguang Li, Los Gatos, CA (US); Corydon Carlson, Stillwater, MN (US)

(73) Assignee: Boston Scientific Scimed, Inc., Maple Grove, MN (US)

(21) Appl. No.: 19/555,727

(22) Filed: Mar. 3, 2026

Related U.S. Application Data
(63) Continuation-in-part of application No. 19/338,520, filed on Sep. 24, 2025.
(60) Provisional application No. 63/699,279, filed on Sep. 26, 2024.

(51) Int. Cl. G06T 7/00; G06T 7/246; G06T 7/262; H04N 23/50

(52) U.S. Cl. CPC G06T 7/0016; G06T 7/248; G06T 7/262; H04N 23/555; G06T 2207/10132; G06T 2207/20056; G06T 2207/30021; G06T 2207/30101

(57) ABSTRACT

The present disclosure is directed towards detecting the potential for and/or buildup of torsional energy in a rotational imaging device. The disclosure can provide an alert to the user, to allow the user to recover from the situation before catastrophic complications (e.g., knotting of the core, or the like) occur. The disclosure provides to correlate sequential images captured by the rotational imaging device to detect the potential for and/or buildup of torsional energy in the device. In particular, rotation between sequential images can be correlated to identify when torsional energy is building in the device.

### CROSS-REFERENCE TO RELATED APPLICATIONS

This patent application is a continuation-in-part application of application Ser. No. 19/338,520, which claims the benefit of priority under 35 U.S.C. § 119 to U.S. Provisional Patent Application No. 63/699,279, filed Sep. 26, 2024, which is herein incorporated by reference in its entirety.

### TECHNICAL FIELD

The present disclosure generally relates to rotational imaging devices and systems and can be implemented to detect the potential for twisting, or the buildup of torque, in the rotating core of the rotational imaging device.

### BACKGROUND

Miniature imaging probes attached to a distal end of a catheter can be inserted into a patient to capture intracorporeal images. Often, such images are used to visualize internal anatomical structures of the patient. For example, an imaging probe (e.g., an ultrasound probe, an optical coherence tomography (OCT) probe, etc.) can be used to visualize vasculature structure, visualize pulmonary structure, or the like. Often, the imaging probe is attached to a distal end of a catheter which is inserted into the patient (e.g., into the patients' cardiac arteries, into the patient's pulmonary lumens, etc.). The imaging probe includes an imaging core which itself can include an imaging device (e.g., ultrasound transducer, optical transducer, etc.) and a driveshaft that extends between the imaging device at the distal end of the catheter and the proximal end of the catheter. At the proximal end of the catheter the driveshaft is coupled to equipment, such as, a motor drive unit and an imaging console. The equipment is configured to rotate the imaging device, power and receive signals from the imaging device, and render images of structure being visualized based on the received signals.

As noted, to visualize a representative portion of the patient's anatomy, the imaging core is often rotated (e.g., via the driveshaft) while the catheter is being moved through the lumen (e.g., pulled proximally or pushed distally). In some cases, where the imaging core is rotated the driveshaft may “wind up” with torsional energy. This torsional energy can cause complications to the procedure, such as, twisting and/or kinking of the driveshaft. Further, such torsional energy can introduce distortions into the images.

Thus, there is a need to detect twisting or build up or torque in the driveshaft of a rational imaging core.

### BRIEF SUMMARY

The present disclosure provides to detect the potential for and/or buildup of torsional energy in a driveshaft of a rotational imaging device. The present disclosure provides a computing device configured to detect buildup of torque in a driveshaft of a rotational imaging device based on detecting abnormal rotation between adjacent received image frames.

For example, the disclosure provides a computing system with memory and a configurable computing circuitry (e.g., a field-programmable gate array (FPGA), or the like) configured to collect and demodulate signals from an image device (e.g., ultrasound transducer, or the like). The configurable computing circuitry can create image frames from the demodulated signals. Further, the configurable computing circuitry can generate a two-dimensional (2D) Fast Fourier Transform (FFT) from the image frames and determine buildup of rotational torque from the 2D FFTs.

With some embodiments, the method can comprise cross-correlating the first image frame and the second image frame to identify the angle of rotation.

With some embodiments, the method can comprise filtering the series of image frames to generate a filtered series of image frames, wherein identifying the angle of rotation between the first image frame and the second image frame comprising identifying the angle of rotation from the filtered series of image frames.

With some embodiments of the method, the control signal comprises an indication of a graphical alert to be displayed on a display.

With some embodiments, the method can comprise determining whether the determined angle of rotation is greater than or equal to a rotation threshold; and generating the control signal based on a determination that the determined angle of rotation is greater than or equal to the rotation threshold.

With some embodiments of the method, the angle of rotation is a first angle of rotation, and the series of image frames comprises at least a third image frame successive to the second image frame, and the method can further comprise identifying a second angle of rotation between the second image frame and the third image frame; and generating the control signal responsive to the first and the second angles of rotation.

With some embodiments of the method, the rotational imaging device is an intravascular ultrasound (IVUS) catheter comprising a distal imaging core coupled to a proximal motor drive unit connector via a driveshaft and wherein the potential twisting of the rotational imaging device corresponds to a potential winding up of the driveshaft.

In some embodiments, the disclosure can be implemented as a rotational imaging device control system, an intravascular ultrasound (IVUS) imaging system, or the like where the system is configured to be coupled to a motor drive unit and an imaging catheter, such as an IVUS catheter. In such embodiments, the system can comprise processing circuitry and a memory comprising instructions, which when executed cause the system to receive, from the IVUS catheter, a series of image frames captured by the IVUS catheter, where the series of image frames comprises at least a first image frame and a second image frame successive to the first image frame; identify an angle of rotation between the first image frame and the second image frame; generate, responsive to the determined angle of rotation, a graphical indication of a potential twisting of the IVUS catheter; and display on a display coupled to the IVUS imaging system the graphical indication.

With some embodiments of the system, the instructions when executed by the processing circuitry further cause the system to cross-correlate the first image frame and the second image frame to identify the angle of rotation.

With some embodiments of the system, the instructions when executed by the processing circuitry further cause the system to filter the series of image frames to generate a filtered series of image frames, wherein the angle of rotation between the first image frame and the second image frame is identified from the filtered series of image frames.

With some embodiments of the system, the instructions when executed by the processing circuitry further cause the system to determine whether the determined angle of rotation is greater than or equal to a rotation threshold; and generate the control signal based on a determination that the determined angle of rotation is greater than or equal to the rotation threshold.

With some embodiments of the system, the angle of rotation is a first angle of rotation, the series of image frames comprises at least a third image frame successive to the second image frame, and the instructions when executed by the processing circuitry further cause the system to identify a second angle of rotation between the second image frame and the third image frame; and generate the control signal responsive to the first and the second angles of rotation.

With some embodiments of the system, the imaging catheter comprises a distal imaging core coupled to a proximal motor drive unit connector via a driveshaft and wherein the potential twisting of the imaging catheter corresponds to a potential winding up of the driveshaft.

With some embodiments of the system, the system comprises the motor drive unit and the imaging catheter.

With some embodiments of the system, the imaging catheter is an IVUS catheter, and the system comprises the IVUS catheter.

In some embodiments, the disclosure can be implemented by a non-transitory computer-readable storage device. The storage device can comprise instructions that when executed by a processor of a rotational imaging device control system, such as, a processor of an intravascular ultrasound (IVUS) imaging system, cause the system to receive, from an IVUS catheter coupled to a motor drive unit, a series of image frames captured by the IVUS catheter, where the series of image frames comprises at least a first image frame and a second image frame successive to the first image frame; identify an angle of rotation between the first image frame and the second image frame; generate, responsive to the determined angle of rotation, a graphical indication of a potential twisting of the IVUS catheter; and display on a display coupled to the IVUS imaging system the graphical indication.

With some embodiments of the storage device, the instructions when executed by the processor further cause the system to cross-correlate the first image frame and the second image frame to identify the angle of rotation.

With some embodiments of the storage device, the instructions when executed by the processor further cause the system to filter the series of image frames to generate a filtered series of image frames, wherein the angle of rotation between the first image frame and the second image frame is identified from the filtered series of image frames.

With some embodiments of the storage device, the instructions when executed by the processing circuitry further cause the system to determine whether the determined angle of rotation is greater than or equal to a rotation threshold; and generate the control signal based on a determination that the determined angle of rotation is greater than or equal to the rotation threshold.

With some embodiments of the storage device, the imaging catheter comprises a distal imaging core coupled to a proximal motor drive unit connector via a driveshaft and wherein the potential twisting of the IVUS catheter corresponds to a potential winding up of the driveshaft.

With some embodiments of the storage device, the imaging catheter is an IVUS catheter.

### BRIEF DESCRIPTION OF THE DRAWINGS

To easily identify the discussion of any element or act, the most significant digit or digits in a reference number refer to the figure number in which that element is first introduced.

FIG. 1 illustrates an embodiment of a rotational imaging system in the form of an intravascular ultrasound (IVUS) imaging system.

FIG. 2A and FIG. 2B illustrate an embodiment of a rotational imaging device, in the form an IVUS catheter, that can be used with the rotational imaging systems of the present disclosure.

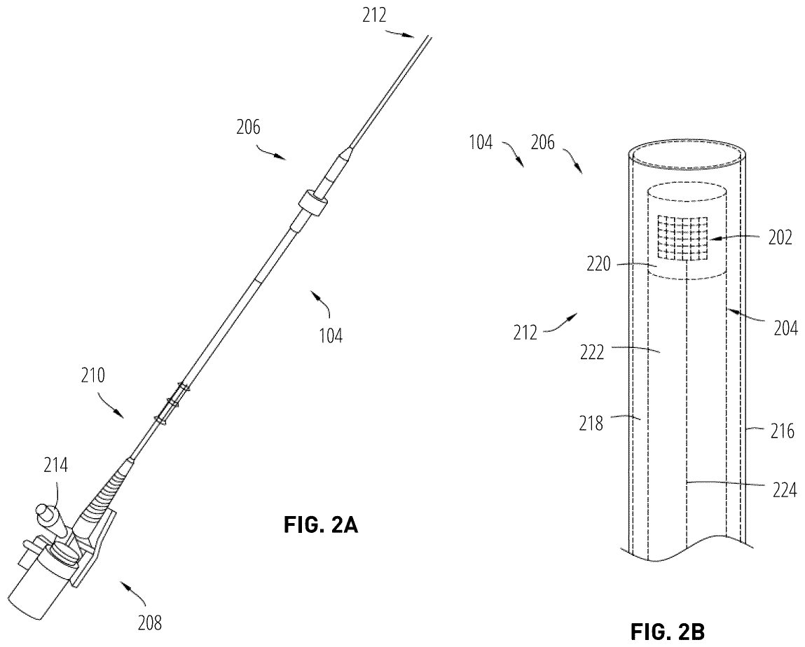

FIG. 3 illustrates an embodiment of a computer subsystem that can be used with the rotational imaging systems of the present disclosure to detect the buildup of torsional energy in a connected rotational imaging device.

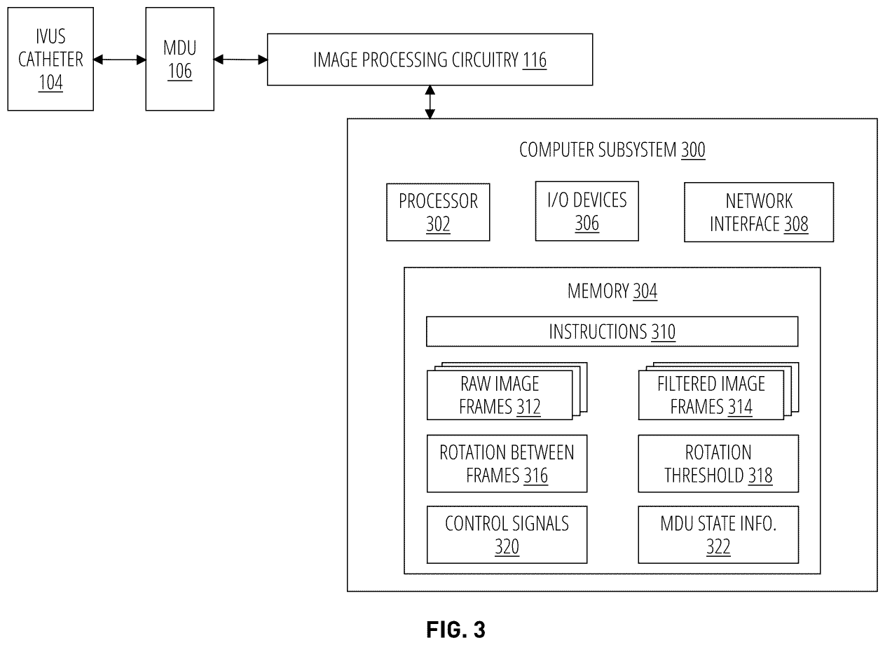

FIG. 4 illustrates an embodiment of a logic flow to detect the buildup of torsional energy in a rotational imaging device.

FIG. 5A, FIG. 5B, and FIG. 5C illustrate an example series of rotational imaging frames.

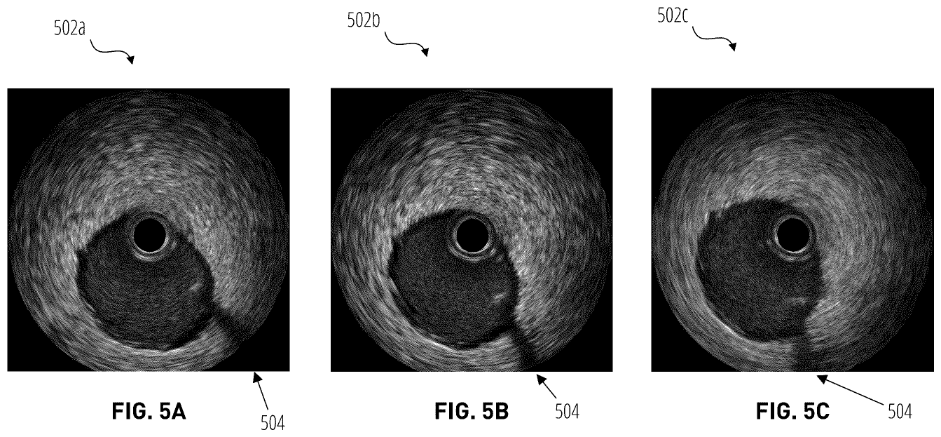

FIG. 6 illustrates an embodiment of a logic flow to detect the buildup of torsional energy in a rotational imaging device.

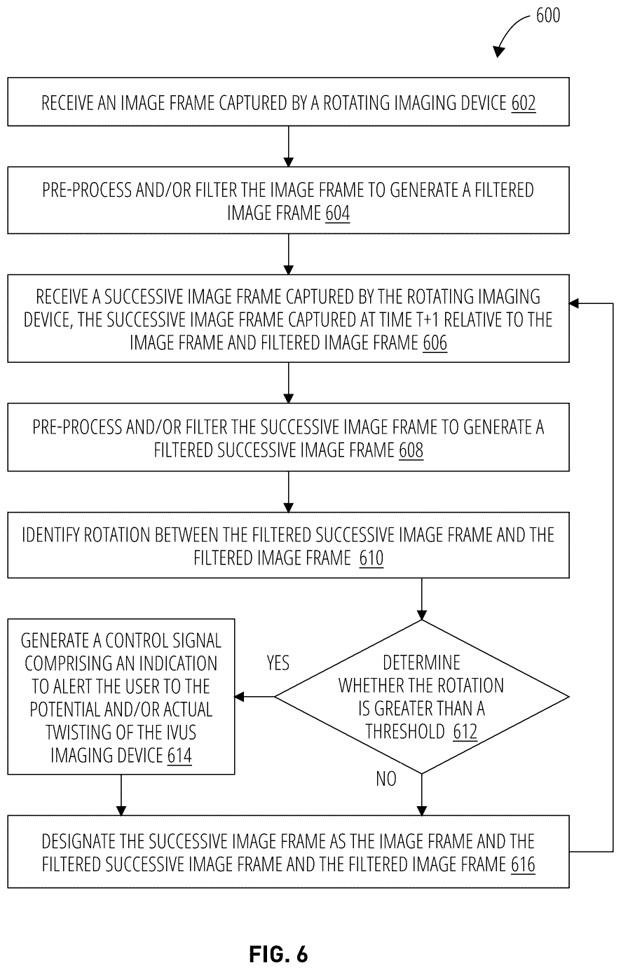

FIG. 7 illustrates another embodiment of a computer subsystem that can be used with the rotational imaging systems of the present disclosure to detect the buildup of torsional energy in a connected rotational imaging device.

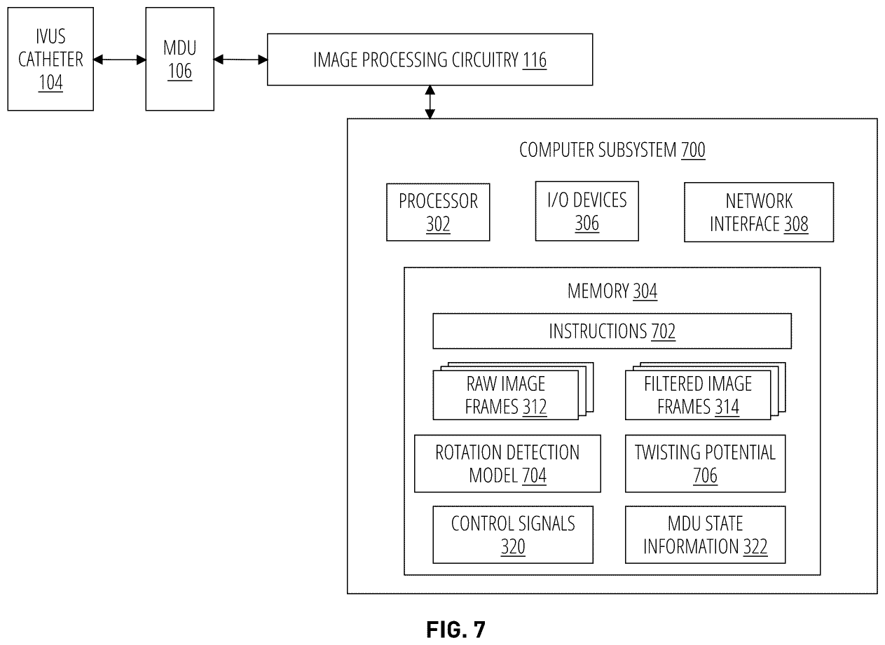

FIG. 8 illustrates another embodiment of a logic flow to detect the buildup of torsional energy in a rotational imaging device.

FIG. 9 illustrates an embodiment of a computer subsystem that can be used with the rotational imaging systems of the present disclosure to detect the buildup of torsional energy in a connected rotational imaging device.

FIG. 10 illustrates an embodiment of a logic flow to detect the buildup of torsional energy in a rotational imaging device.

FIG. 11A illustrates a first data flow corresponding to the logic flow of FIG. 10.

FIG. 11B illustrates a second data flow corresponding to the logic flow of FIG. 10.

FIG. 12 illustrates an embodiment of a computer-readable storage medium.

FIG. 13 illustrates an embodiment of a field programmable gate array (FPGA).

FIG. 14 illustrates an embodiment of a computing system configured to implement any of the methods, techniques, or logic flows detailed herein.

### DETAILED DESCRIPTION

The foregoing has broadly outlined the features and technical advantages of the present disclosure such that the following detailed description of the disclosure may be better understood. It is to be appreciated by those skilled in the art that the embodiments disclosed may be readily utilized as a basis for modifying or designing other structures for carrying out the same purposes of the present disclosure. The novel features of the disclosure, both as to its organization and operation, together with further objects and advantages will be better understood from the following description when considered in connection with the accompanying figures. It is to be expressly understood, however, that each of the figures is provided for the purpose of illustration and description and is not intended as a definition of the limits of the present disclosure.

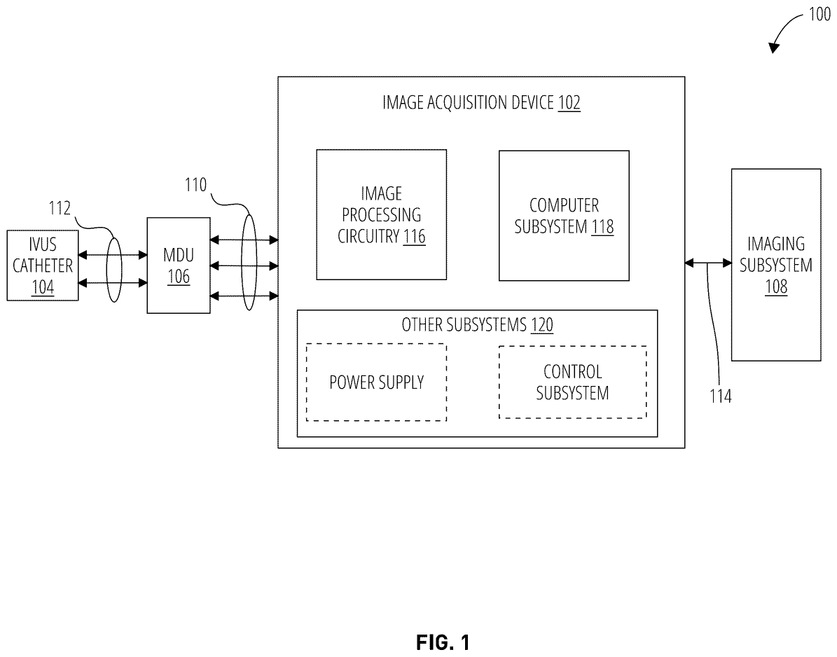

As introduced above, the disclosure provides methods and computer systems to detect potential for and/or actual twisting of a rotational imaging core driveshaft. As used herein, the term “twisting” means a difference in the rate of rotation between the proximal end of the driveshaft and the distal end of the drive shaft. As such, an example rotational imaging system is described. Although the disclosure can be implemented to detect the build-up of torsional energy in any rotational imaging system, an intravascular ultrasound (IVUS) system is used in the balance of the disclosure for purposes of clarity of presentation only and not as a necessary limitation. FIG. 1 illustrates an example IVUS imaging system 100. The IVUS imaging system 100 includes an image acquisition device 102, an IVUS catheter 104, a motor drive unit (MDU) 106, and an imaging subsystem 108. The image acquisition device 102 is coupled to the IVUS catheter 104 via the MDU 106 and is also coupled to the imaging subsystem 108. In particular, the image acquisition device 102 is coupled to the MDU 106 via the MDU bus 110 while the MDU 106 is coupled to the IVUS catheter 104 via the catheter bus 112. In some embodiments, the MDU bus 110 and the catheter bus 112 can be transmission lines (or other conductors) arranged to convey signals between the various components. For example, the MDU bus 110 and catheter bus 112 can be arranged to transmit radio frequency signals (e.g., control signals, ultrasound pulse generation signals, ultrasound signals, or the like) between the indicated components of the IVUS imaging system 100.

As outlined above, the driveshaft 222 is rotatable. For example, the driveshaft 222 can be rotated manually. In other embodiments, the driveshaft 222 can be rotated using a computer-controlled drive mechanism (e.g., MDU 106). Rotation of the driveshaft 222 causes the imaging device 220 and the transducers 202 attached to the imaging device to be rotated. Signals emitted and received by the transducers 202 can be used to form radial cross-sectional image of the anatomy (e.g., vasculature, etc.) as described above. However, where the distal end 212 of the IVUS catheter 104 is advanced through tortious and/or narrow anatomy while the imaging device 220 is rotated, friction between the imaging device 220 and the sheath 216 may cause torsional energy to accumulate in the driveshaft 222. Said differently, in such scenarios, the distal end of the driveshaft 222 may rotate at a different rate than the proximal end of the driveshaft 222, causing the driveshaft to “twist” and/or buildup torsional energy.

Like computer subsystem 300, computer subsystem 700 can be any of a variety of computing devices but will in general include processing circuitry and memory. With some examples, the processing circuitry (e.g., processor 302) can be and/or can include specialized processing circuitry for executing ML models. In computer subsystem 700, memory 304 can include instructions 710, raw image frames 312, filtered image frames 314, rotation detection model 716, twisting potential 718, control signals 320 and/or MDU state information 322.

During operation, processor 302 can execute instructions 710 to cause computer subsystem 700 to receive raw image frames 312 from image processing circuitry 116. Processor 302 can further execute instructions 710 to filter and/or pre-process raw image frames 312 to generate filtered image frames 314. Further, processor 302 can execute instructions 310 to generate twisting potential 718 from raw image frames 312 or filtered image frames 314 and rotation detection model 716. Said differently, processor 302 can execute instructions 310 to infer twisting potential 718 from rotation detection model 716 where raw image frames 312 or filtered image frames 314 are used as inputs to rotation detection model 716.

In some examples, rotation detection model 716 can be any of a variety of ML models. Rotation detection model 716 can be an image classification model, such as, a neural network (NN), a convolutional neural network (CNN), a random forest model, or the like. Generally, rotation detection model 716 is arranged to infer twisting potential 718 from raw image frames 312 or filtered image frames 314. For example, given a pair of successive image frames (e.g., first and second image frames 502a and 502b, second and third image frames 502b and 502c, or the like) rotation detection model 716 can infer a twisting potential 718. In some examples, twisting potential 718 is a binary twisting or no twisting detected. Rotation detection model 716 can be trained using any of a variety of training methodologies. Such as, for example, supervised or unsupervised learning. In a simple example, several sets of annotated image frames where the image frames are annotated to indicate whether they depict twisting buildup or not can be provided. Rotation detection model 716 could be trained using an optimization function and loss function to generate a trained rotation detection model 716 where it can infer from a series (or pair) of images whether twisting is building up or not.

With some examples, rotation detection model 716 can be configured to infer twisting potential 718 from filtered image frames 314 (or raw image frames 312 as may be the case) and MDU state information 322. With some examples, filtered image frames 314 can be filtered raw image frames or filtered images in the frequency domain (e.g., masked 2D FFT frames).

Processor 302 can execute instructions 710 to generate control signals 320 responsive to twisting potential 718 comprising an indication that twisting is likely, imminent, or already occurred.

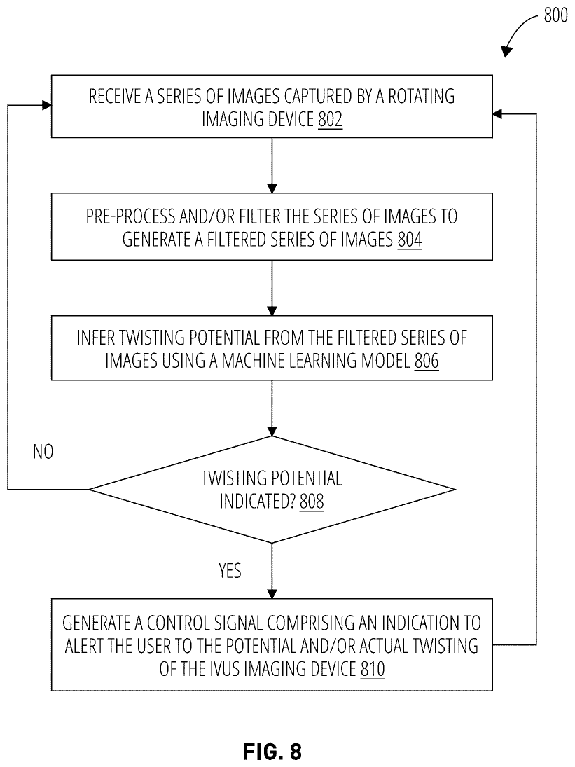

FIG. 8 illustrates a logic flow 800 to identify potential and/or actual twisting of a rotational imaging driveshaft, according to some embodiments of the present disclosure. The logic flow 800 can be implemented by computer subsystem 700, which itself can be implemented by IVUS imaging system 100. Further, logic flow 800 will be described with reference to computer subsystem 700 for clarity of presentation. However, it is noted that logic flow 800 could also be implemented by an IVUS imaging system different than IVUS imaging system 100.

Logic flow 800 can begin at block 802. At block 802 “receive a series of images captured by a rotating imaging device” a series of images captured by a rotating imaging device can be received. For example, computer subsystem 300 can receive a series of images captured by imaging device 220 of IVUS catheter 104 via image processing circuitry 116. Processor 302 can execute instructions 710 to receive information and/or data comprising indications of raw image frames 312.

Continuing to block 804 “pre-process and/or filter the series of images to generate a filtered series of images” the series of images received at block 802 can be pre-processed and/or filtered. For example, processor 302 can execute instructions 710 to filter the raw image frames 312 to generate filtered image frames 314. It is noted that block 804 is optional and, in some embodiments, logic flow 800 will proceed from block 802 to block 806.

Continuing to block 806 “infer twisting potential from the filtered series of images using a machine learning model” a twisting potential can be inferred from the filtered series of images (or the raw images as may be the case) using an ML model. For example, processor 302 can execute instructions 710 to generate (or infer) twisting potential 718 from filtered image frames 314 using rotation detection model 716. Alternatively, where block 804 is not executed, processor 302 can execute instructions 710 to generate (or infer) twisting potential 718 from raw image frames 312 using rotation detection model 716. As another example, processor 302 can execute instructions 710 to generate (or infer) twisting potential 718 from filtered image frames 314 and MDU state information 322 using rotation detection model 716.

Continuing to decision block 808 “twisting potential indicated?” a determination of whether twisting potential is indicated by twisting potential 718 can be made. For example, processor 302 can execute instructions 710 to determine whether the twisting potential 718 has a confidence level above a threshold. From decision block 808, logic flow 800 can continue to block 810 or return to block 802. For example, where at decision block 808 a determination is made that the twisting potential is indicated, logic flow 800 can continue to block 810 from decision block 808. At block 810 “generate a control signal comprising an indication to alert the user to the potential and/or actual twisting of the IVUS imaging device” a control signal comprising an indication to alert the user to the potential and/or actual twisting of the IVUS catheter 104 can be generated. For example, processor 302 can execute instructions 710 to generate a graphical alert to be displayed on a display where the graphical alert includes an indication of possible and/or actual twisting of the driveshaft 222 of the IVUS catheter 104. As another example, processor 302 can execute instructions 710 to generate an audible alert to be emitted by a speaker where the audible alert includes an indication of possible and/or actual twisting of the driveshaft 222 of the IVUS catheter 104.

From block 810, logic flow 800 can return to block 802. Alternatively, where at decision block 808 a determination is made that the twisting potential is not indicated, logic flow 800 can return to block 802 from decision block 808. In such a manner, logic flow 800 can be repeatedly or iteratively executed to identify the potential for and/or actual twist of an IVUS catheter 104 during a procedure as image frames are captured. In such an iterative example, at further instances of block 802, additional successive image frames (e.g., n+, or the like) can be received and the logic flow 800 can be implemented to determine whether there is a potential for twisting of kinking of the IVUS catheter 104 based on these additionally captured image frames.

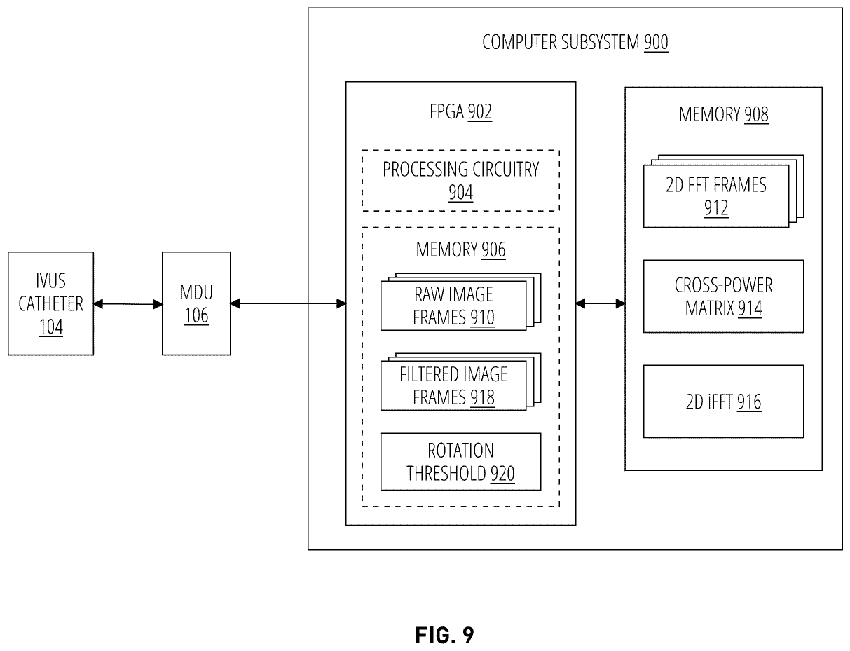

FIG. 9 illustrates an example of a computer subsystem 900, which can be implemented as part of the IVUS imaging system 100 of FIG. 1. For example, computer subsystem 900 could be implemented as computer subsystem 118 of IVUS imaging system 100 and configured to correlate consecutive images captured by IVUS catheter 104 and detect the potential for and/or actual twist of the driveshaft 222 based on the images. Image processing circuitry 116 can include analog processing circuitry configured to transform electrical signals received from the IVUS catheter 104, and particularly from the transducer 202, into digital signals that can be processed by computer subsystem 900.

Computer subsystem 900 can be any of a variety of computing devices but will in general include FPGA 902 and memory 908. In some embodiments, computer subsystem 900 can be embodied as an FPGA (as depicted) or an Application Specific Integrated Circuit (ASIC).

The computer subsystem 900 can be communicatively coupled to MDU 106 and IVUS catheter 104. In some embodiments, computer subsystem 900 can be embodied with image processing circuitry 116. That is, the processing circuitry of image processing circuitry 116 that is configured to transform the analog signals received from IVUS catheter 104 can also include processing circuitry configured to detect twisting as outlined herein. As a specific example, a combination image processing circuitry 116 and computer subsystem 900 could be implemented with an FPGA. However, for purposes of clarity of presentation only, computer subsystem 900 is depicted and described herein distinct from image processing circuitry 116.

As depicted computer subsystem 900 can include FPGA 902, which itself comprises compute circuitry The FPGA can further include processing circuitry 904 and memory 906. The FPGA 902, and particularly the processing circuitry 904 can be configured to perform compute operations as described herein.

Further, the computer subsystem 900 can comprise memory 908, which can be additional memory to what is available on the FPGA 902. The memory 906 and 908 may include logic, a portion of which includes arrays of integrated circuits, forming non-volatile memory to persistently store data or a combination of non-volatile memory and volatile memory. It is to be appreciated, that the memory 908 may be based on any of a variety of technologies. In particular, the arrays of integrated circuits included in memory 120 may be arranged to form one or more types of memory, such as, for example, dynamic random-access memory (DRAM), NAND memory, NOR memory, or the like.

During operation, the processing circuitry 904 can be configured to receive signals from the IVUS catheter 104 (e.g., from the transducer 202, or the like) and demodulate the signal. For example, processing circuitry 904 can generate an envelope signal (e.g., amplitude profile) from signals received from the transducer 202. It is to be appreciated by those of skill in the art, 2D images (e.g., grayscale ultrasound images) can be formed by mapping the amplitude profile to spatial location. These images can be referred to as B-mode images. Accordingly, this figure depicts the FPGA 902 configured to received signals from transducer 202 and generate raw image frames 910 from these signals. With some embodiments, the raw image frames 910 are square grayscale images. With a specific example, raw image frames 910 can be a 256 pixel by 256 pixel gray scale images.

Further, the processing circuitry 904 can be configured to generate 2D FFT frames 912 from the raw image frames 910. This is described in greater detail below. However, in general, the processing circuitry 904 can derive one-dimensional (1D) FFTs along a dimension (e.g., row, column, or the like) of a frame of the raw image frames 910 to create a 2D FFT for the frame of the raw image frames 910.

With some examples, processing circuitry 904 can apply various image filtering algorithms to the raw image frames 910 (e.g., a Gaussian filter, a two-dimension (2D) matrix filter, a blur filter, a segmentation filter, or the like) to generate filtered image frames 918. In such examples, processing circuitry 904 can generate the 2D FFT frames 912 from the filtered image frames 918.

Additionally, processing circuitry 904 can derive a cross-power matrix 914 from the 2D FFT frames 912. For example, processing circuitry 904 can derive cross-power matrix 914 from a point-by-point multiplication and division calculation of the 2D FFT frames 912. Further, processing circuitry 904 can derive 2D iFFT 916 as the inverse FFT of the cross-power matrix 914.

Processing circuitry 904 can further identify a location of the maximum displacement or rotation between raw image frames 910 from value at the identified location. In some embodiments, processing circuitry 904 can compare this value to rotation threshold 920 and generate control signals based on the comparison. For example, where the maximum exceeds the rotation threshold 920 processing circuitry 904 can send a control signal to the MDU 106 to cause the MDU 106 to change (e.g., reduce or modulate the speed of rotation). In other examples, control signals can be control signals to be sent to the MDU 106 to cause the MDU 106 to stop rotation. With still other examples, control signals can be control signals to be sent to a display (e.g., a display of imaging subsystem bus 114, or the like) to cause the display to provide a graphical alert to the user of the potential for twisting of the driveshaft 222. With yet other examples, control signals can be control signals to be sent to a speaker (e.g., a speaker of IVUS imaging system 100, or the like) to cause the speaker to provide an audible alert to the user of the potential for twisting of the driveshaft 222.

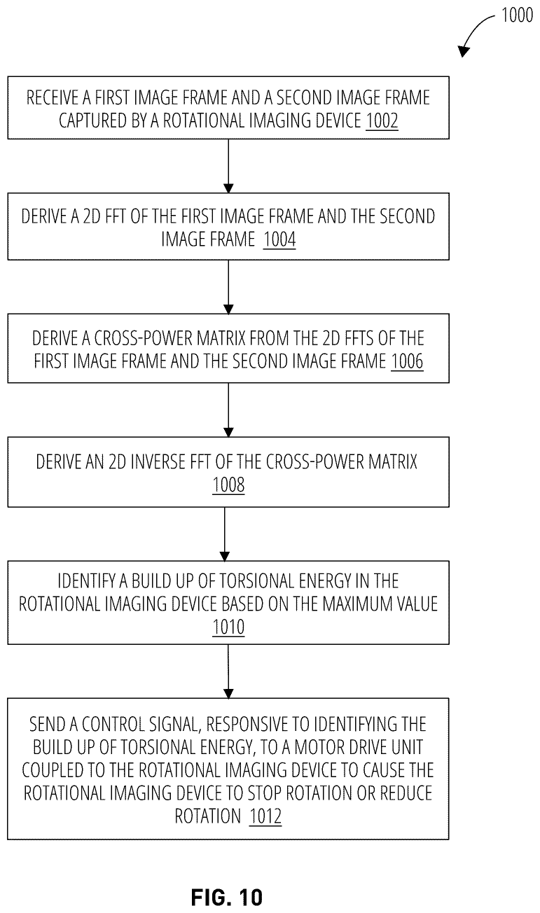

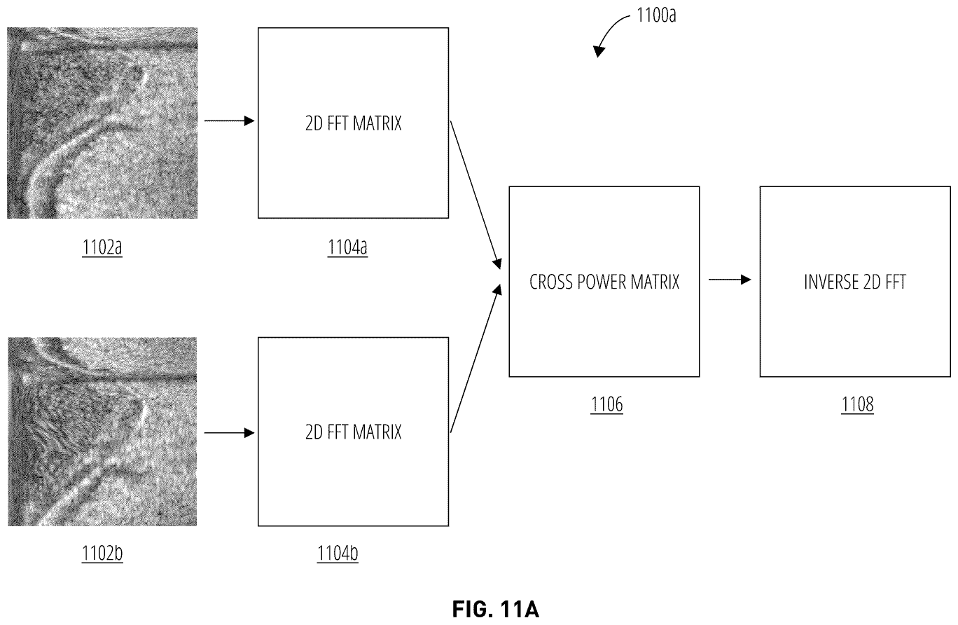

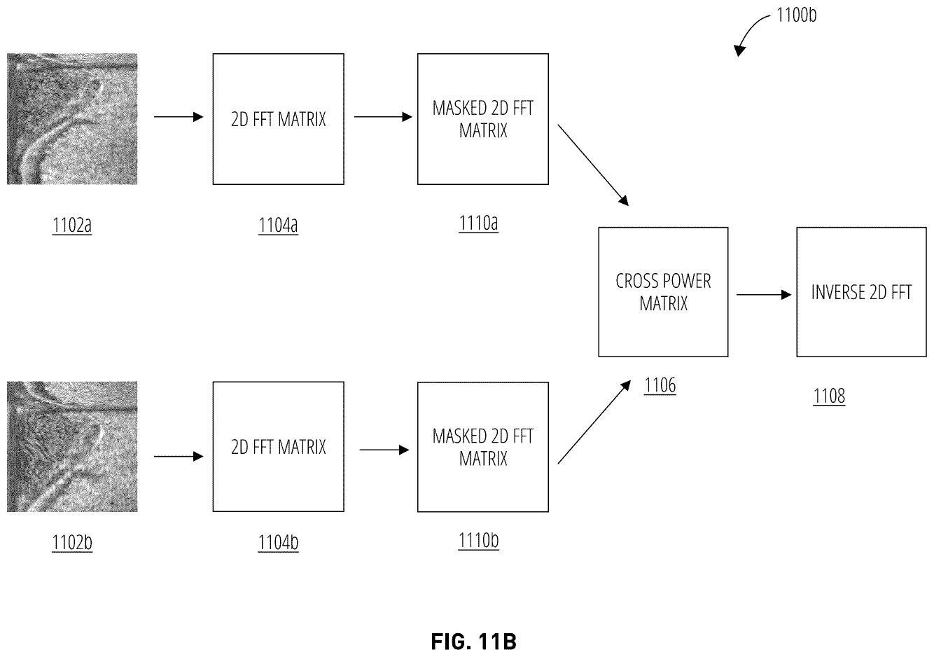

FIG. 10 illustrates a logic flow 1000 to identify potential and/or actual twisting of a rotational imaging driveshaft, according to some embodiments of the present disclosure. The logic flow 1000 can be implemented by computer subsystem 900, which itself can be implemented by IVUS imaging system 100. Further, logic flow 1000 will be described with reference to computer subsystem 900 for clarity of presentation. However, it is noted that logic flow 1000 could also be implemented by an IVUS imaging system different than IVUS imaging system 100. Additionally, logic flow 1000 is described with reference to the example frames depicted in FIG. 11.

Logic flow 1000 can begin at block 1002. At block 1002 “receive a first image frame and a second image frame captured by a rotational imaging device” images frames captured by a rotating imaging device can be received. For example, processing circuitry 904 can receive raw image frames 910. In some embodiments the first frame can correspond to a frame captured at time (t) equals n−1 while the second frame can correspond to a frame captured at time (t) equals n. For example, processing circuitry 904 can receive images frames image frame 1102a and image frame 1102b. In some embodiments, processing circuitry 904 can receive signals from transducer 202 of IVUS catheter 104 can demodulate the signals and generate the raw image frames 910 from the signals.

Continuing to block 1004 “derive a 2D FFT of the first image frame and the second image frame” 2D FFTs of the first and second image frame can be derived. For example, processing circuitry 904 can derive FFTs of the raw image frames 910 to generate the 2D FFT frames 912. As a specific example, processing circuitry 904 can derive the FFT of image frame 1102a to generate the 2D FFT frame 1104a and the FFT of the image frame 1102b to generate the image frame 1102b.

With some embodiments, processing circuitry 904 can derive row and column wise 1D FFTs of the images to generate 2D FFTs of the images. More specifically, processing circuitry 904 can derive the 1D FFT of the image frame 1102a along one dimension (e.g., row wise), resulting in an intermediate matrix and then derive the 1D FFT of the intermediate matrix along the opposite dimension (e.g., column wise), resulting in the 2D FFT frames 1104a.

Continuing to block 1006 “derive a cross-power matrix from the 2D FFTs of the first image frame and the second image frame” a cross-power matrix from the 2D FFTs can be derived. For example, processing circuitry 904 can derive the cross-power matrix 914 from the 2D FFT frames 912. In some embodiments, the cross-power matrix 914 can be derived as the 2D FFT of one image multiplied by the complex conjugate of the 2D FFT of the second image. It is to be appreciated by those of ordinary skill in the art that such operations can result in a matrix represented as follows:

$${R}_{j , k} = \frac{{G}_{a , jk} {G}_{b , jk}^{*}}{\vert {G}_{a , jk} {G}_{b , jk}^{*} \vert} ,$$

where R is the cross-power matrix Gₐ is the 2D FFT frame 1104a and Gb is the 2D FFT frame 1104b. For example, processing circuitry 904 can derive the dot product of the 2D FFT frame 1104b and the complex conjugate of the 2D FFT frame 1104a to derive the cross-power matrix 1106.

Continuing to block 1008 “derive an inverse 2D FFT of the cross-power matrix” an inverse 2D FFT of the cross-power matrix can be derived. For example, processing circuitry 904 can derive the 2D iFFT 916 from as the inverse FFT of the cross-power matrix 914. With some embodiments, processing circuitry 904 can derive the 1D inverse FFT of the cross-power matrix 914 along one dimension (e.g., row wise), resulting in an intermediate matrix and then derive the 1D inverse FFT of the intermediate matrix along the opposite dimension (e.g., column wise), resulting in the inverse 2D FFT 1108.

Continuing to block 1010 “identify a buildup of torsional energy in the rotational imaging device based on the maximum value” a buildup of torsional energy in the IVUS catheter 104 can be identified based on the 2D iFFT 916. For example, processing circuitry 904 can identify a buildup of torsional energy in the driveshaft 222 of the IVUS catheter 104 based on the 2D iFFT 916. As a specific example, processing circuitry 904 can identify a maximum value of the 2D iFFT 916. In such an example, processing circuitry 904 can identify a location in the 2D iFFT 916 of the maximum and then the maximum value from this location (e.g., based on a maximum location finding algorithm and/or a maximum value identification algorithm such as MAXLOC, or the like). Further, processing circuitry 904 can compare this maximum value to a threshold value and can determine whether torsional energy is building based on the comparison. For example, where the maximum is greater than the rotation threshold 920, processing circuitry 904 can determine that the torsional energy in the driveshaft 222 is building.

Continuing to block 1012 “send a control signal, responsive to identifying the buildup of torsional energy, to a motor drive unit coupled to the rotational imaging device to cause the rotational imaging device to stop rotation or reduce rotation” a control signal can be send to the MDU 106 to cause the motor drive unit (MDU) 106 to stop or reduce rotation of the IVUS catheter 104 to reduce or eliminate the torsional energy that is building.

FIG. 11A illustrates an example data flow (or image flow) 1100a according to the embodiments described herein. As outlined above in conjunction with logic flow 1000 of FIG. 10, in data flow 1100a, image frames 1102a and 1102b can be received. Further, 2D FFT frames 1104a and 1104b can be derived from the image frames 1102a and 1102b, respectively. Additionally, a cross-power matrix 1106 can be derived from the dot product of the 2D FFT frame 1104b and the complex conjugate of the 2D FFT frame 1104a. Further still, the inverse 2D FFT 1108 can be derived from the cross-power matrix 1106 and rotation or buildup of torsional energy in a rotational imaging device can be identified from the maximum values of the inverse 2D FFT 1108.

FIG. 11B illustrates another example data flow (or image flow) 1100b according to the embodiments described herein. The data flow 1100b can comprise a similar flow to that shown and described in conjunction with the data flow 1100a and FIG. 11A. However, data flow 1100b can correspond to embodiments where filtering is applied. For example, filtered 2D FFT frames 1110a and 1110b can be derived from the 2D FFT frames 1104a and 1104b, respectively (e.g., based on a masking operation, or the like). For example, a mask having a fixed size (e.g., 32 pixels by 32 pixels, or the like) of non-zero values with other values being zero, can be used to derive the filtered 2D FFT frames 1110a and 1110b. With some specific embodiments, the non-zero values can be one (1).

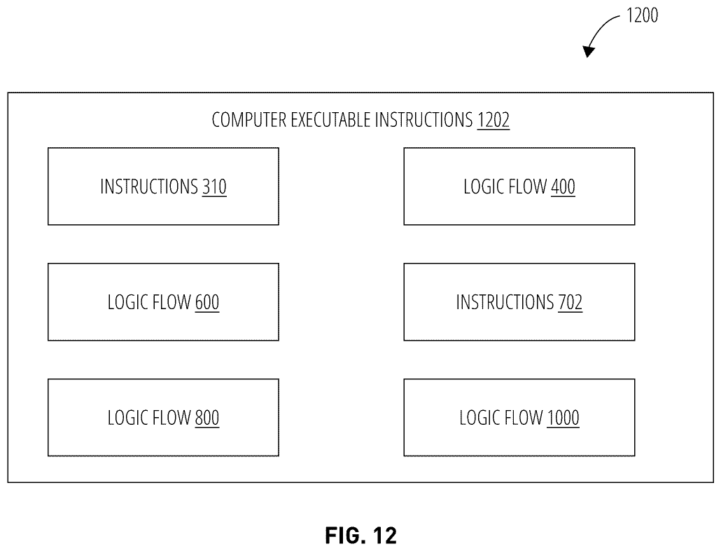

FIG. 12 illustrates computer-readable storage medium 1200. Computer-readable storage medium 1200 may comprise any non-transitory computer-readable storage medium or machine-readable storage medium, such as an optical, magnetic or semiconductor storage medium. In various embodiments, computer-readable storage medium 1200 may comprise an article of manufacture. In some embodiments, computer-readable storage medium 1200 may store computer executable instructions 1202 with which circuitry (e.g., processor 302, or the like) can execute. For example, computer executable instructions 1202 can include instructions to implement operations described with respect to instructions 310, logic flow 400, logic flow 600 instructions 702, logic flow 800 and/or logic flow 1000. Examples of computer-readable storage medium 1200 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 1202 may include any suitable type of code, such as source code, compiled code, interpreted code, executable code, static code, dynamic code, object-oriented code, visual code, and the like.

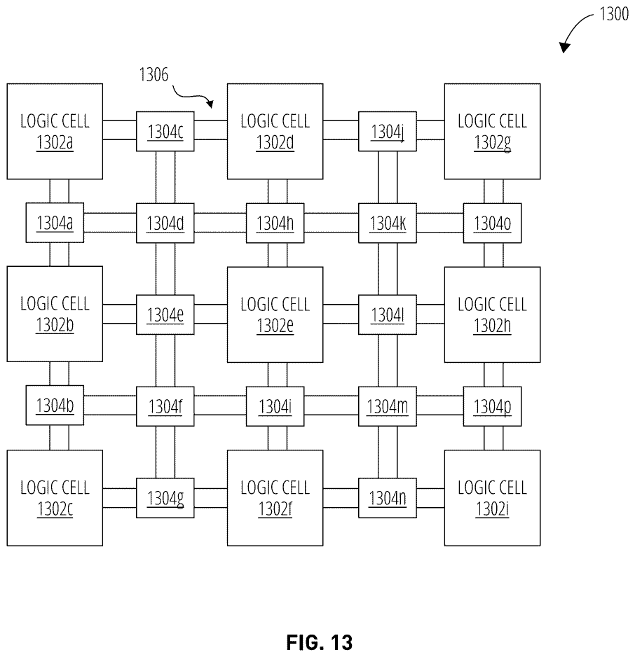

FIG. 13 illustrates an example FPGA 1300, according to at least one embodiment of the disclosure. The FPGA 1300 is a reconfigurable integrated circuit comprising a number of configurable logic cells. For example, FPGA 1300 is depicted with logic cells 1302a through 1302i. Each one of the logic cells 1302a to 1302i are interconnected via a number of programmable switches and routing fabric 1306. For example, logic cells 1302a to 1302i are interconnected via switches 1304a through 13040. Further, the routing fabric 1306 is coupled to input/output circuitry (not shown).

The FPGA 1300 may be configured to execute one or more processing tasks in hardware, for example, identification of torsional energy builds up in a rotational imaging device from image frames captured by the device as outlined above. For example, the logic cells 1302a through 1302i and switches 1304a through 13040 can be individually configured such that the configured FPGA 1300 performs the operations for the logic flows described herein (e.g., logic flow 1000, or the like) in hardware.

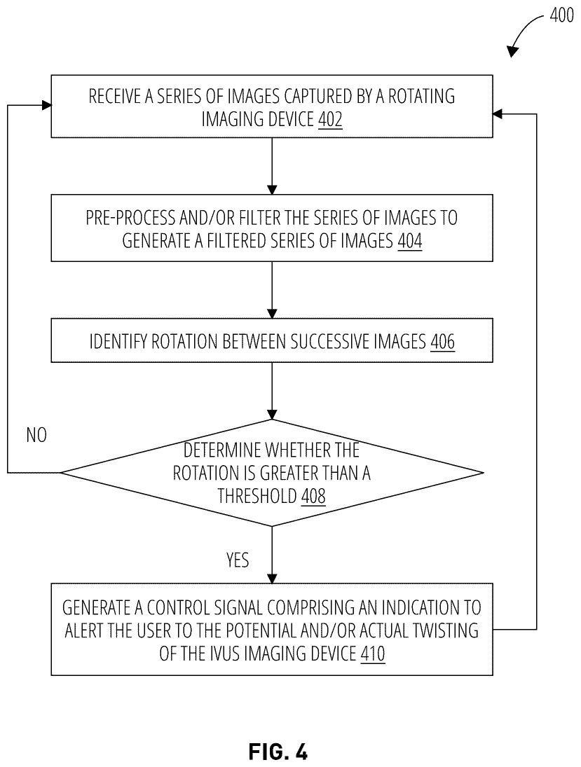

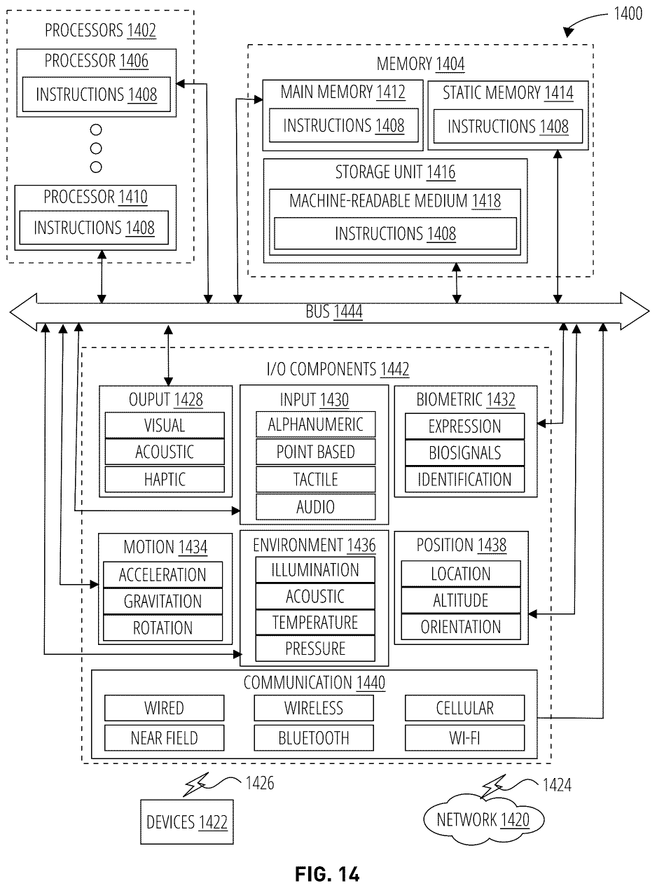

FIG. 14 illustrates a diagrammatic representation of a machine 1400 in the form of a computer system within which a set of instructions may be executed for causing the machine to perform any one or more of the methodologies discussed herein. More specifically, FIG. 14 shows a diagrammatic representation of the machine 1400 in the example form of a computer system, within which instructions 1408 (e.g., software, a program, an application, an applet, an app, or other executable code) for causing the machine 1400 to perform any one or more of the methodologies discussed herein may be executed. For example, the instructions 1408 may cause the machine 1400 to execute logic flow 400 of FIG. 4, logic flow 800 of FIG. 8, or the like. More generally, the instructions 1408 may cause the machine 1400 to identify potential and/or actual twisting of the driveshaft 222 of IVUS catheter 104 and provide an alert to the user. In such a manner, the user can be provided an opportunity to recover the situation (e.g., by backing out the catheter, unwinding the core, or the like).

The instructions 1408 transform the general, non-programmed machine 1400 into a particular machine 1400 programmed to carry out the described and illustrated functions in a specific manner. In alternative embodiments, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1408, sequentially or otherwise, that specify actions to be taken by the machine 1400. Further, while only a single machine 1400 is illustrated, the term “machine” shall also be taken to include a collection of machines 200 that individually or jointly execute the instructions 1408 to perform any one or more of the methodologies discussed herein.

The machine 1400 may include processors 1402, memory 1404, and I/O components 1442, which may be configured to communicate with each other such as via a bus 1444. In an example embodiment, the processors 1402 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1406 and a processor 1410 that may execute the instructions 1408. The term “processor” is intended to include multi-core processors that may comprise two or more independent processors (sometimes referred to as “cores”) that may execute instructions contemporaneously. Although FIG. 14 shows multiple processors 1402, the machine 1400 may include a single processor with a single core, a single processor with multiple cores (e.g., a multi-core processor), multiple processors with a single core, multiple processors with multiples cores, or any combination thereof.

The memory 1404 may include a main memory 1412, a static memory 1414, and a storage unit 1416, both accessible to the processors 1402 such as via the bus 1444. The main memory 1404, the static memory 1414, and storage unit 1416 store the instructions 1408 embodying any one or more of the methodologies or functions described herein. The instructions 1408 may also reside, completely or partially, within the main memory 1412, within the static memory 1414, within machine-readable medium 1418 within the storage unit 1416, within at least one of the processors 1402 (e.g., within the processor's cache memory), or any suitable combination thereof, during execution thereof by the machine 1400.

The I/O components 1442 may include a wide variety of components to receive input, provide output, produce output, transmit information, exchange information, capture measurements, and so on. The specific I/O components 1442 that are included in a particular machine will depend on the type of machine. For example, portable machines such as mobile phones will likely include a touch input device or other such input mechanisms, while a headless server machine will likely not include such a touch input device. It will be appreciated that the I/O components 1442 may include many other components that are not shown in FIG. 14. The I/O components 1442 are grouped according to functionality merely for simplifying the following discussion and the grouping is in no way limiting. In various example embodiments, the I/O components 1442 may include output components 1428 and input components 1430. The output components 1428 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1430 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1442 may include biometric components 1432, motion components 1434, environmental components 1436, or position components 1438, among a wide array of other components. For example, the biometric components 1432 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1434 may include acceleration sensor components (e.g., accelerometer), gravitation sensor components, rotation sensor components (e.g., gyroscope), and so forth. The environmental components 1436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1438 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1442 may include communication components 1440 operable to couple the machine 1400 to a network 1420 or devices 1422 via a coupling 1424 and a coupling 1426, respectively. For example, the communication components 1440 may include a network interface component or another suitable device to interface with the network 1420. In further examples, the communication components 1440 may include wired communication components, wireless communication components, cellular communication components, Near Field Communication (NFC) components, Bluetooth® components, Wi-Fi® components, and other communication components to provide communication via other modalities. The devices 1422 may be another machine or any of a wide variety of peripheral devices (e.g., a peripheral device coupled via a USB).

Moreover, the communication components 1440 may detect identifiers or include components operable to detect identifiers. For example, the communication components 1440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes, and other optical codes), or acoustic detection components (e.g., microphones to identify tagged audio signals). In addition, a variety of information may be derived via the communication components 1440.

The various memories (i.e., memory 1404, main memory 1412, static memory 1414, and/or memory of the processors 1402) and/or storage unit 1416 may store one or more sets of instructions and data structures (e.g., software) embodying or utilized by any one or more of the methodologies or functions described herein. These instructions (e.g., the instructions 1408), when executed by processors 1402, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1420 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1420 or a portion of the network 1420 may include a wireless or cellular network, and the coupling 1424 may be a Code Division Multiple Access (CDMA) connection, a Global System for Mobile communications (GSM) connection, or another type of cellular or wireless coupling. In this example, the coupling 1424 may implement any of a variety of types of data transfer technology.

The instructions 1408 may be transmitted or received over the network 1420 using a transmission medium via a network interface device (e.g., a network interface component included in the communication components 1440) and utilizing any one of a number of well-known transfer protocols (e.g., hypertext transfer protocol (HTTP)). Similarly, the instructions 1408 may be transmitted or received using a transmission medium via the coupling 1426 (e.g., a peer-to-peer coupling) to the devices 1422. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1408 for execution by the machine 1400, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to one or multiple ones. Additionally, the words “herein,” “above,” “below” and words of similar import, when used in this application, refer to this application as a whole and not to any portions of this application. When the claims use the word “or” in reference to a list of two or more items, that word covers all the following interpretations of the word: any of the items in the list, all the items in the list and any combination of the items in the list, unless expressly limited to one or the other. Any terms not expressly defined herein have their conventional meaning as commonly understood by those having skill in the relevant art(s).

What is claimed is:

1. A hardware device to identify the potential twisting of a rotational imaging device used for intravascular imaging, comprising:
a memory; and
processing circuitry, the processing circuitry configured to:
receive a first image frame and a second image frame captured by a rotational imaging device during an percutaneous intervention (PCI) procedure;
derive a two-dimensional (2D) Fast Fourier Transform (FFT) of the first image frame and the second image frame;
derive a cross-power matrix from the 2D FFTs of the first image frame and the second image frame;
derive an 2D inverse FFT of the cross-power matrix; and
identify a buildup or torsional energy in the rotational imaging device based in part on the 2D inverse FFT.

2. The hardware device of claim 1, wherein the processing circuitry is configured to:
receive signals from an ultrasound transducer of the rotational imaging device at a time (t=n−1) and demodulate the signals to form the first image; and
receive other signals from the ultrasound transducer at a time (t=n) and demodulate the other signals to form the second image.

3. The hardware device of claim 1, wherein the processing circuitry is configured to:
derive a one-dimensional (1D) FFT of the first image along a first dimension to generate an intermediate matrix;
derive a 1D FFT of the intermediate matrix along a second dimension opposite the first dimension to generate the 2D FFT of the first image;
derive a 1D FFT of the second image along the first dimension to generate a second intermediate matrix; and
derive a 1D FFT of the second intermediate matrix along the second dimension to generate the 2D FFT of the second image.

4. The hardware device of claim 1, wherein the processing circuitry is configured to:
apply a binary frequency-domain mask to the 2D FFT of the first image frame and the second image frame, wherein each element of the binary frequency-domain mask includes a value of either zero (0) or one (1) such that frequency components above a cutoff frequency are suppressed.

5. The hardware device of claim 4, wherein the first dimension is row wise, and the second dimension is column wise.

6. The hardware device of claim 1, wherein the processing circuitry is configured to:
derive the complex conjugate of the 2D FFT of the first image;
derive the dot product of the 2D FFT of the second image and the complex conjugate of the 2D FFT of the first image to derive the cross-power matrix.

7. The hardware device of claim 1, wherein the processing circuitry is configured to:
derive a one-dimensional (1D) inverse FFT of the cross-power matrix along a first dimension to generate an intermediate cross-power matrix; and
derive a 1D inverse FFT of the cross-power intermediate matrix along a second dimension opposite the first dimension to generate the 2D inverse FFT.

8. The hardware device of claim 1, wherein the processing circuitry is configured to:
identify a maximum value of the 2D inverse FFT;
determine whether the maximum value is greater than or equal to a rotational threshold value; and
identify, responsive to a determination that the maximum is greater than or equal to the threshold value, a buildup or torsional energy in the rotational imaging device.

9. The hardware device of claim 1, wherein the processing circuitry is configured to send, to a motor drive unit coupled to the rotational imaging device responsive to identifying the buildup of torsional energy in the rotational imaging device, a control signal to cause the motor drive unit to stop or reduce rotation of the rotational imaging device.

10. The hardware device of claim 1, wherein the processing circuitry is a field programmable gate array (FPGA).

11. The hardware device of claim 10, wherein the memory is external to the FPGA.

12. The hardware device of claim 1, wherein the first image frame and the second image frame are 256 pixel by 256 pixel gray scale images.

13. The hardware device of claim 1, wherein the processing circuitry is configured to identify the buildup or torsional energy in the rotational imaging device during a procedure in which the first image frame and the second image frame are captured.

14. An intravascular imaging system comprising:
a rotational imaging device used for intravascular imaging;
a motor drive unit coupled to the rotational imaging device; and
an imaging console coupled to the motor drive unit, the imaging console comprising:
a memory; and
processing circuitry, the processing circuitry configured to:
receive a first image frame and a second image frame captured by a rotational imaging device during a percutaneous intervention (PCI) procedure;
derive a two-dimensional (2D) Fast Fourier Transform (FFT) of the first image frame and the second image frame;
derive a cross-power matrix from the 2D FFTs of the first image frame and the second image frame;
derive an 2D inverse FFT of the cross-power matrix; and
identify a buildup or torsional energy in the rotational imaging device based in part on the 2D inverse FFT.

15. The intravascular imaging system of claim 14, wherein the processing circuitry is configured to:
derive a one-dimensional (1D) FFT of the first image along a first dimension to generate an intermediate matrix; and
derive a 1D FFT of the intermediate matrix along a second dimension opposite the first dimension to generate the 2D FFT of the first image.

16. The intravascular imaging system of claim 14, wherein the processing circuitry is configured to:
identify a maximum value of the 2D inverse FFT;
determine whether the maximum value is greater than or equal to a rotational threshold value; and
identify, responsive to a determination that the maximum is greater than or equal to the threshold value, a buildup or torsional energy in the rotational imaging device.

17. The intravascular imaging system of claim 14, wherein the processing circuitry is configured to send, to a motor drive unit coupled to the rotational imaging device responsive to identifying the buildup of torsional energy in the rotational imaging device, a control signal to cause the motor drive unit to stop or reduce rotation of the rotational imaging device.

18. A field programmable gate array (FPGA) configured to identify the potential twisting of a rotational imaging device used for intravascular imaging, the FPGA configured to:
receive a first image frame and a second image frame captured by a rotational imaging device during a percutaneous intervention (PCI) procedure;
derive a two-dimensional (2D) Fast Fourier Transform (FFT) of the first image frame and the second image frame;
derive a cross-power matrix from the 2D FFTs of the first image frame and the second image frame;
derive an 2D inverse FFT of the cross-power matrix; and
identify a buildup or torsional energy in the rotational imaging device based in part on the 2D inverse FFT.

19. The FPGA of claim 18, wherein the processing circuitry is configured to:
derive a one-dimensional (1D) FFT of the first image along a first dimension to generate an intermediate matrix; and
derive a 1D FFT of the intermediate matrix along a second dimension opposite the first dimension to generate the 2D FFT of the first image.

20. The FPGA of claim 18, wherein the processing circuitry is configured to:
identify a maximum value of the 2D inverse FFT;
determine whether the maximum value is greater than or equal to a rotational threshold value; and
identify, responsive to a determination that the maximum is greater than or equal to the threshold value, a buildup or torsional energy in the rotational imaging device.
